(19) United States
(12) Patent Application Publication
(10) Pub. No.: US 2004/0268332 A1
(43) Pub. Date: Dec. 30, 2004

(54) Memory access control method and processing system with memory access check function

(76) Inventors: Masato Mitsumori, Yokohama (JP); Kei Nakajima, Chigasaki (JP); Satoshi Iesaka, Yokohama (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/829,205

(22) Filed: Apr. 22, 2004

(30) Foreign Application Priority Data
Apr. 23, 2003 (JP) 2003-118602

(51) Int. Cl. G06F 9/45

(52) U.S. Cl. 717/154; 717/162

(57) ABSTRACT

An invalid memory access detection program early detects invalid memory access caused by a program operating in a system in which memory access can be freely performed, said program being called from a program operating in a system in which invalid memory access does not occur. An execution program of the Java VM executes a Java byte code that has been read. A native method library execution module calls a native method library, and executes it. During or after the execution of the native method library, an invalid memory access detection module checks a memory area reserved by the memory reservation module, and thereby detects invalid memory access caused by the native method library.

### CLAIM OF PRIORITY

The present application claims priority from the Japanese patent application JP2003-118602 filed on Apr. 23, 2003, the content of which is hereby incorporated by reference into this application.

### BACKGROUND OF THE INVENTION

The present invention relates to a memory access control method and a processing system with a memory access check function.

The Java VM is generally known as an object-oriented language, and is an environment for executing a Java program. The Java VM specially manages a memory area that is used when executing a Java program. The Java VM is a system in which invalid memory access does not occur so long as the Java program is executed (Java is a registered trademark of Sun Microsystems, Inc. in the United States).

However, an OS manages a memory area during the execution of a program that is called if necessary when a Java program is executed but that is created in another language (for example, C language). Accordingly, it is not possible to detect in the Java VM whether or not invalid memory access has occurred during that time. Therefore, there is a possibility that the program created in another language, which has been called by the Java program, will access by mistake the memory area managed by the Java VM, and consequently will update the memory area. However, a technique for early detecting such invalid memory access is not known.

Incidentally, this kind of technique, for example, is related to JPA 6-44129, JPA 5-28053, and the like.

### SUMMARY OF THE INVENTION

In the above-mentioned prior art, during the execution of a program that is called if necessary when a Java program is executed but that is created in another language, the program in said another language invalidly may access the memory area managed by the Java VM to update the memory area. In this case, it is not possible to detect the occurrence of invalid memory access until a Java program, which will be executed after that, accesses the memory area and results in an abnormal condition, and it was difficult to identify the program having a problem.

An object of the present invention is to early detect invalid memory access caused by a program operating in a system in which memory access can be freely performed, said program being called from a program operating in a system in which invalid memory access does not occur.

The present invention is characterized by a technique for early detecting the occurrence of invalid memory access during or after the execution of a program operating in a system in which memory access can be freely performed, said program being called from a program operating in a system in which invalid memory access does not occur.

### BRIEF DESCRIPTION OF THE DRAWING

FIG. 1 is a diagram illustrating a configuration of the Java VM according to an embodiment;

FIG. 2 is a flowchart illustrating processing steps of an execution program 108 according to the embodiment;

FIG. 3 is a flowchart illustrating processing steps of a first embodiment;

FIG. 4 is a diagram illustrating invalid memory access in the first embodiment;

FIG. 5 is a flowchart illustrating processing steps of a second embodiment;

FIG. 6 is a diagram illustrating invalid memory access in the second embodiment;

FIG. 7 is a flowchart illustrating processing steps of a third embodiment; and

FIG. 8 is a flowchart illustrating processing steps of a fourth embodiment.

### DESCRIPTION OF THE PREFERRED EMBODIMENTS

Preferred embodiments will be described with reference to drawings as below. Hereinafter, the Java VM is used as a system in which no invalid memory access occurs. Programs described in Java are used for programs operating in the system. A native method library described in the C language is used for programs operating in a system in which memory access can be freely performed.

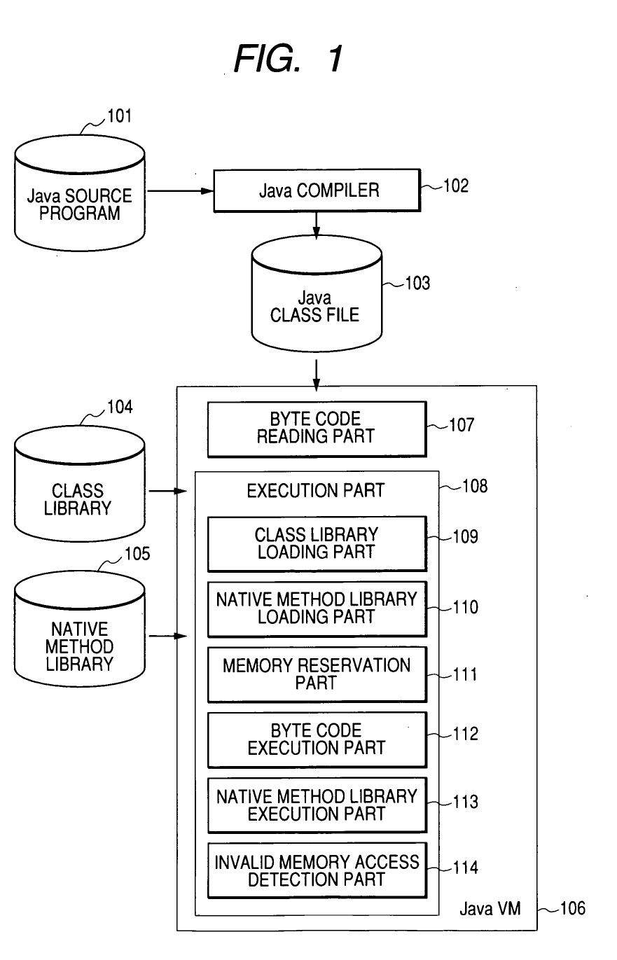

FIG. 1 is a diagram illustrating how the Java VM and an input file according to the embodiment are configured. Reference numeral 101 denotes a Java source program stored in a storage device. Reference numeral 102 denotes a Java compiler for converting the Java source program into a byte code described in an intermediate language so that the Java source program can be executed in the Java VM. Reference numeral 103 denotes a Java class file in which the byte code created by the Java compiler are stored. Reference numeral 104 denotes the other byte codes required to execute the byte code, i.e., a class library in which the class file is stored. Reference numeral 105 denotes a native method library described in a language other than the Java language that is called by the byte code. Reference numeral 106 denotes a main body of the Java VM that is a language system for embodying the present invention. Reference numeral 107 denotes a byte code reading part(program) for loading in a memory the byte code of the Java class file 103. Reference numeral 108 denotes an execution part (program) for calling the inputted byte code and the native method library 105 to actually execute a Java program. The execution program 108 comprises a class library loading part (module) 109 for loading a class file in which the other byte codes required for executing the byte code are stored; a native method library loading part(module) 110 for loading in the memory the native method library 105 described in a language other than the Java language; a memory reservation part(module) 111 for reserving a memory area required for the Java VM when the Java program is executed; a byte code execution part(module) 112 for executing a byte code; a native method library execution part(module) 113 for executing the native method library 105; and an invalid memory access detection part(module) 114 for detecting whether or not invalid memory access occurs during or after the execution of the native method library.

The module 109,110,111,112,113 or 114 may be called the program 109,110,111,112,113 or 114 instead.

Incidentally, although it is not illustrated, the Java VM 106 is under the control of an OS (operating system). This OS has a native memory management function. The native method library reserves its own memory area by use of the memory management function possessed by this OS. Needless to say, the Java compiler 102, the Java VM 106, and the OS shown in FIG. 1 are programs executed by a CPU of a computer comprising a CPU, a memory, a storage device, an input device, and a display device. The Java source program 101, the Java class file 103, the class library 104, and the native method library 105 are program codes stored in this storage device. The Java class file 103, the class library 104, and the native method library 105 are program codes executed by this computer.

Upon reception of a command through the input device, the Java VM 106 starts up and the execution of the Java VM 106 begins. Reading the byte code from the Java-class file 103, the byte code reading program 107 directs its control to the execution module 108 so that the byte code execution module 112 executes the byte code that has been read.

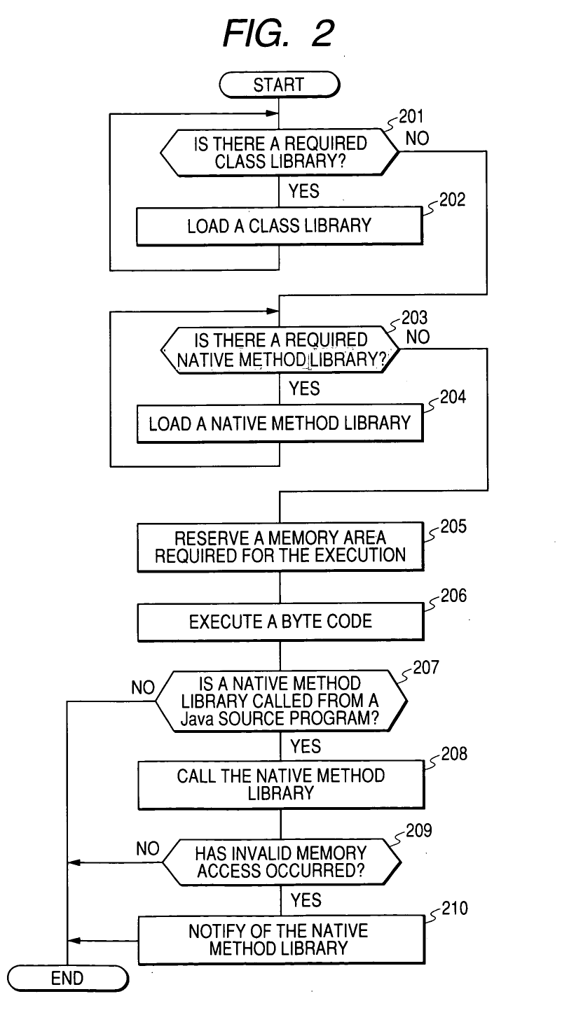

FIG. 2 is a flowchart illustrating processing steps of the execution program 108 according to the present invention. Steps 201, 202 perform processing of the class library loading module 109 that loads into a memory the class library 104 required to execute the byte code. Steps 203, 204 perform processing of the native method library loading module 110 that loads into the memory the native method library 105 required to execute the byte code. A step 205 performs processing of the memory reservation module 111 that reserves a memory required when the inputted byte code in the Java VM is executed. A step 206 performs processing of the byte code execution module 112 that actually executes the byte code. Steps 207, 208 perform processing of the native method library execution module 113 that executes a native method library. Steps 209, 210 perform processing of the invalid memory access detection module 114 that detects whether or not invalid memory access has occurred when the native method library is executed.

When the byte code is inputted, the class library loading module 109 makes a judgment in the step 201 whether or not there is any other required byte code. If there is a required byte code, in the step 202, a class library is loaded into a memory from the class library 104 that stores the byte code.

The native method library loading module 110 makes a judgment whether or not the byte code inputted in the step 203 has processing of calling a native method library that is described in a language other than the Java language. If the byte code has processing of calling a native method library, in the step 204, the native method library loading module 110 loads the native method library into the memory from the native method library 105.

In the step 205, by use of the memory management function that is specially possessed by the Java VM 106, the memory reservation module 111 reserves a memory area required to execute the byte code in the Java VM. Even if invalid memory access occurs in future, the Java VM 106 writes the whole reserved memory area to a memory management table so that it can be detected. In addition, the memory reservation module 111 also collects a memory area that becomes unused.

In the step 206, the byte code execution module 112 actually executes the byte code. In the step 207, the native method library execution module 113 makes a judgment whether or not a native method library described in a language other than the Java language is called from the byte code that is currently being executed. If it is judged that a native method library is called, the native method library is called in the step 208, and then the control of the execution is passed to the called native method library.

In the step 209, during or after the execution of the native method library, the invalid memory access detection module 114 detects whether or not invalid memory access has occurred. If invalid memory access has occurred, a native method library in question is notified to the outside in the step 210. The invalid memory access detection module 114 displays an error message on the display device, or outputs the error message to a specified file. Upon the completion of the above-mentioned processing of the execution program 108, the control returns again to the byte code reading program 107.

(1) First Embodiment

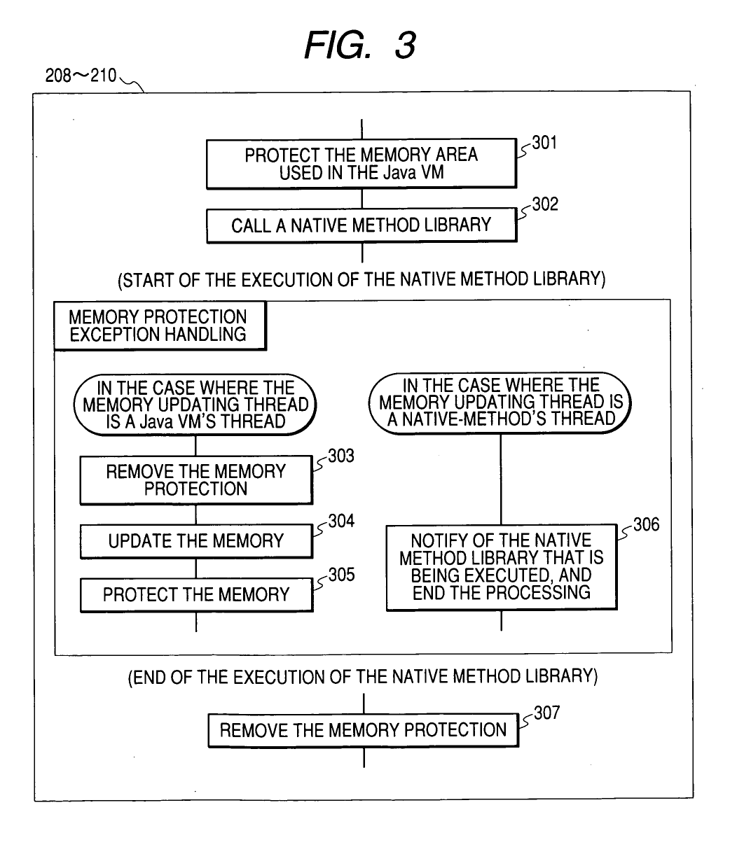

FIG. 3 is a flowchart of processing executed in the case where the OS has a memory protection function and processing of the steps 208 through 210 is included in a system capable of the multithread control. In a step 301, the native method library execution module 113 enables the write protection of a memory area used in the Java VM, which has been reserved in the processing of the step 205, so that even if invalid memory access occurs in the processing of a native method library to be called, it can be detected. In a step 302, the native method library execution module 113 calls a native method library.

When the memory area which has been protected is accessed during the execution of the native method library, and a memory protection exception occurs, the control is returned to the Java VM 106. If the thread which has accessed the protected memory area is a thread operating in the Java VM, an exception handling program (invalid memory access detection module 114) of the Java VM 106 temporarily disables the protection of the memory area in a step 303, and then in the step 304, the exception handling program normally updates the memory area, the protection of which has been disabled. In the step 305, the protection of the memory area is enabled again. The steps 303 through 305 are performed as atomic transactions so that another thread does not access the memory area. After the native method library ends, the control returns, and then the processing before calling the native method library is continued. In addition, if the thread which has accessed the protected memory area is a thread of the native method library, in a step 306, a program of the native method library is notified as an error message, and then the processing ends.

After the execution of the native method library ends without occurrence of exception, as soon as the control returns to the Java VM 106, the native method library execution module 113 disables the memory protection in a step 307.

If it is instructed that the memory area used in the Java VM should not be protected, processing of the steps 301, 303, 305, 307 is not executed. To be more specific, if it is judged that the native method library does not cause invalid memory access, overhead processing can be eliminated.

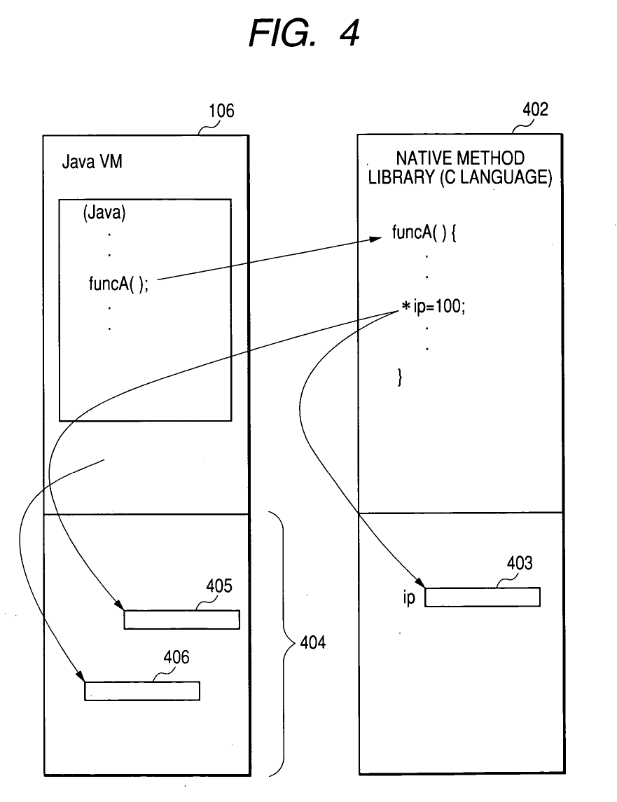

FIG. 4 is a diagram illustrating an example in which the OS has the memory protection function and invalid memory access occurs in a system, which is capable of the multithread control, during the execution of the native method library called in the step 302.

FIG. 4 illustrates a state in which processing of the native method library 402 described in the C language, which operates in a system where memory access can be freely performed, is called from a Java program that operates in a system of the Java VM 106 where invalid memory access does not occur. The native method library (funcA) 402 originally tries to update an area 403 that is pointed by a pointer ip. However, the native method library (funcA) 402 tries, by mistake, to update an area 405 in the memory area 404, the write protection of which is enabled. In this case, a memory protection exception of the thread to be updated occurs because of the thread operating in the native method library. The exception handling program of the Java VM 106 notifies of the native method library (funcA) being executed at that time, and then ends. If the thread which has tried to update the area 406 in the memory area 404, the write protection of which is enabled, is a thread operating in the Java VM, the Java VM 106 disables this write protection to allow the update of the area 406, and then enables the write protection of the memory area 404 again.

(2) Second Embodiment

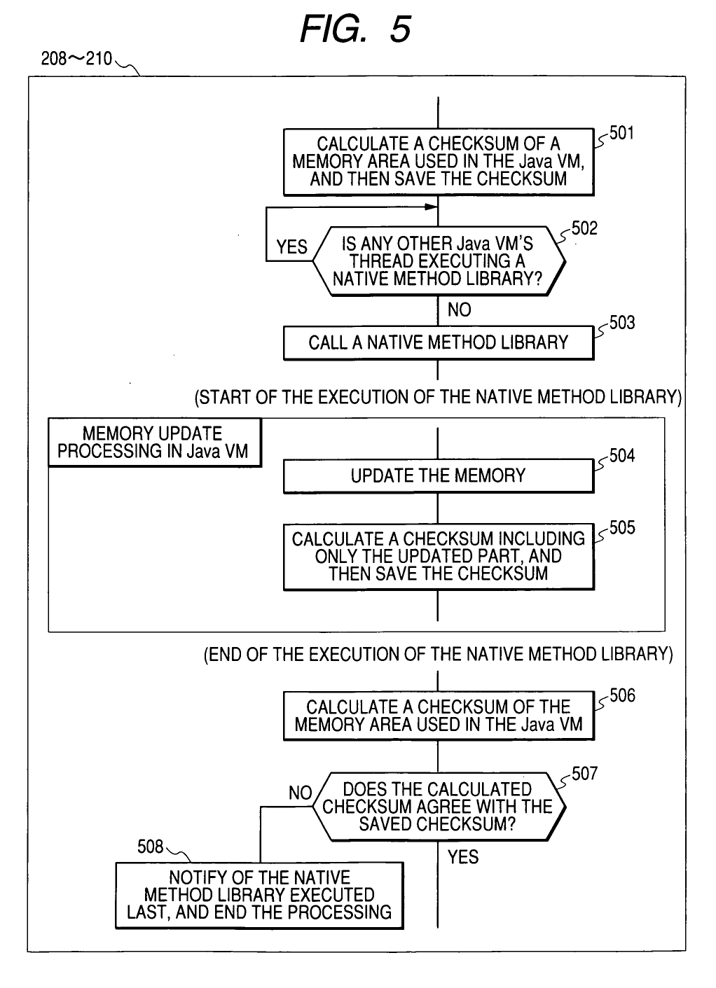

FIG. 5 is a flowchart of processing executed in the case where the OS does not have the memory protection function and processing of the steps 208 through 210 is included in the system capable of the multithread control. In a step 501, the native method library execution module 113 calculates a checksum of the contents of the memory area which has been reserved in the processing of the step 205 and which is used in the Java VM. Then, the native method library execution module 113 saves the checksum in a storage area. This processing is performed as an atomic transaction so that another thread does not update the memory area and the checksum is prevented from being updated.

If invalid memory access occurs when a plurality of threads are executing a native method library, it is not possible to identify a thread in which the native method library having a problem is being executed. With the object of avoiding such a state, in a step 502, if a thread of the other Java VM is executing the native method library 105, the native method library execution module 113 waits until the execution of the native method library 105 by the thread ends. After that, in a step 503, the native method library execution module 113 calls a native method library.

If the thread operating in the Java VM updates the memory, original memory update is allowed in the step 504, and then in the step 505, the difference between before and after the update, that is to say, only a part updated by the thread of the Java VM, is calculated, and then the checksum saved in the step 501 is updated by the new checksum. This processing is performed as an atomic transaction so that another thread does not update the memory area and the checksum is prevented from being updated.

When the thread operating in the Java VM updates the memory, if a thread of the other Java VM does not call a native method library, it is not necessary to perform the processing in a step 505. If the thread of the native method library updates the memory area, the processing continues just as it is even if invalid memory access occurs.

When the processing is returned from the native method library, in a step 506, the native method library execution module 113 performs as an atomic transaction the processing of determining a current checksum of contents of the memory area which has been reserved by the processing in the step 205 and which is used in the Java VM. In the step 507, the invalid memory access detection module 114 compares the saved checksum with the checksum determined in the step 506. If they do not coincide with each other, in the step 508, the native method library called last is notified to the outside as an error message before ending the processing.

If it is instructed that a checksum of the memory area used in the Java VM should not be determined, processing of the steps 501, 502 and of the steps 505 through 508 are not executed.

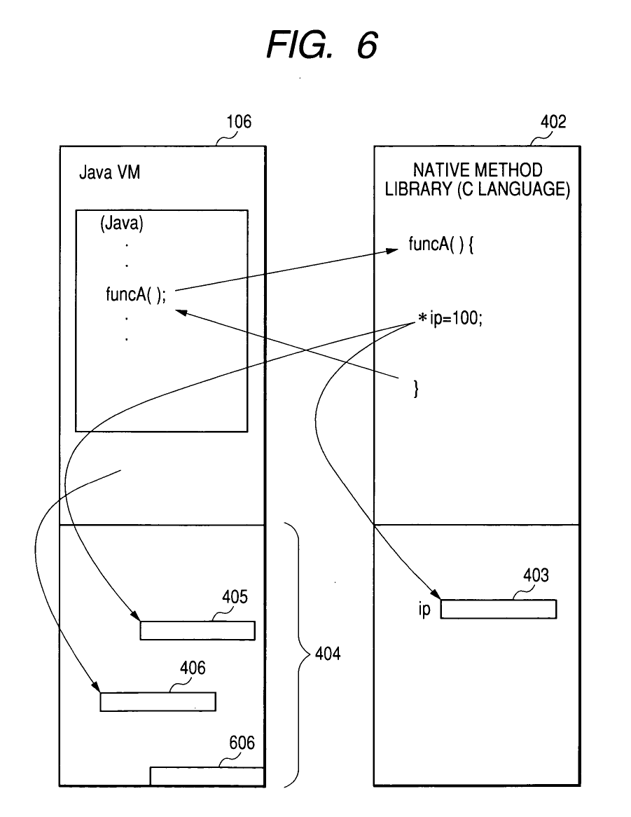

FIG. 6 is a diagram illustrating an example in which the OS does not have the memory protection function and invalid memory access occurs in a system, which is capable of the multithread control, during the execution of the native method library called in the step 503.

FIG. 6 illustrates a state in which processing of the native method library 402 described in the C language, which operates in a system where memory access can be freely performed, is called from a Java program that operates in a system of the Java VM 106 where invalid memory access does not occur. Before calling the native method library 402, the native method library execution module 113 saves a checksum into an area 606 in the memory area 404 used in the Java VM (step 501). The native method library (funcA) 402 originally tries to update an area 403 that is pointed by a pointer ip. However, the native method library (funcA) 402 updates by mistake an area 405 in the memory area 404 used in the Java VM, and the processing normally ended by chance. In this case, the control returns again to a part in the Java program from which the processing of the native method library 402 is called. Immediately after that, a checksum of the memory area 404 used in the Java VM is determined (step 506), and then a comparison is made between the determined checksum and the checksum saved in the area 606 (step 507). Because the area 405 in the memory area 404 used in the Java VM is invalidly updated, the comparison results do not coincide with each other. Accordingly, the invalid memory access detection module 114 notifies that there is a problem in the last called native method library 402, and then ends the processing. If the thread operating in the Java VM updates the area 406 in the memory area 404, the write protection of which is enabled by a checksum, the difference between before and after the update of the area 406 is determined, and then a value of the checksum saved in the area 606 is updated (step 505).

Incidentally, the area 606 for storing the checksum value is not limited to the memory area 404. An arbitrary memory or a storage device may also be used as the area for storing the checksum value.

(3) Third Embodiment

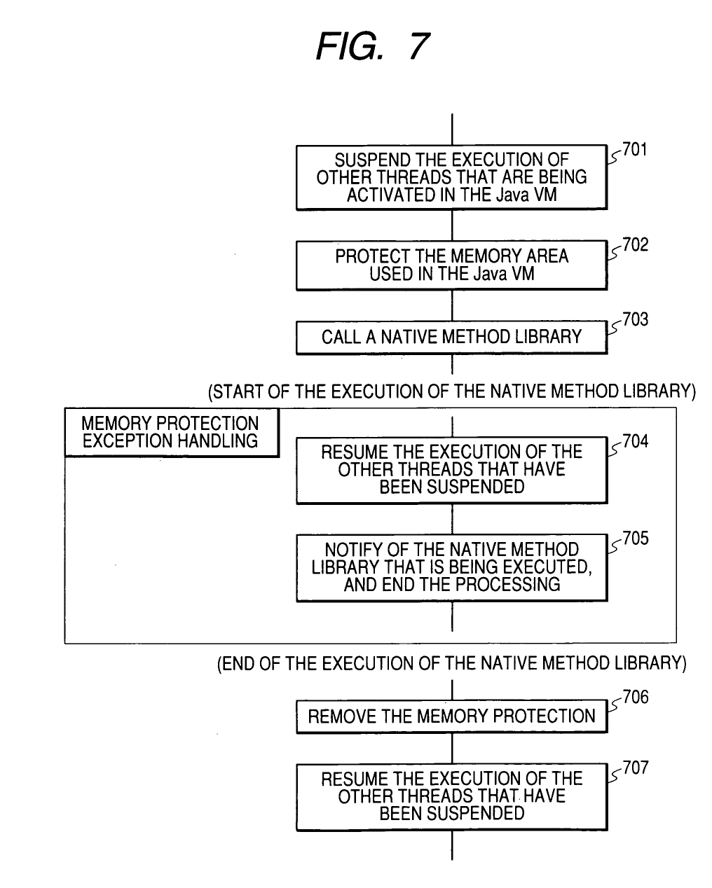

FIG. 7 is a flowchart illustrating processing of the steps 208 through 210 executed in the case where the OS has the memory protection function, and in a system capable of the multithread control, when a native method library is called from the Java VM, another thread operating in the Java VM can be stopped. In a step 701, the execution program 108 suspends the execution of other threads in the Java VM, which is currently activated, so that other threads activated in the Java VM do not access the memory area used in the Java VM, the write protection of which will be enabled now. In a step 702, the execution program 108 enables the protection of the memory area used in the Java VM, which has been reserved in the processing of the step 205, so that even if invalid memory access occurs in the processing of a native method library that will be called now, it can be detected.

In a step 703, the native method library execution module 113 calls the native method library. During the execution of the native method library, if the memory area which has been protected is accessed and a memory protection exception occurs, other threads in the Java VM, which has been suspended, are resumed in the step 704. Because the thread which has accessed the memory area is not a thread of the Java VM, in a step 705, the invalid memory access detection module 114 notifies of a program of the native method library which is being executed at that time, and then ends the processing.

When the processing normally returns from the native method library, the execution program 108 disables the memory protection in a step 706, and then another thread in the Java VM, which has been stopped, is restarted in a step 707.

(4) Fourth Embodiment

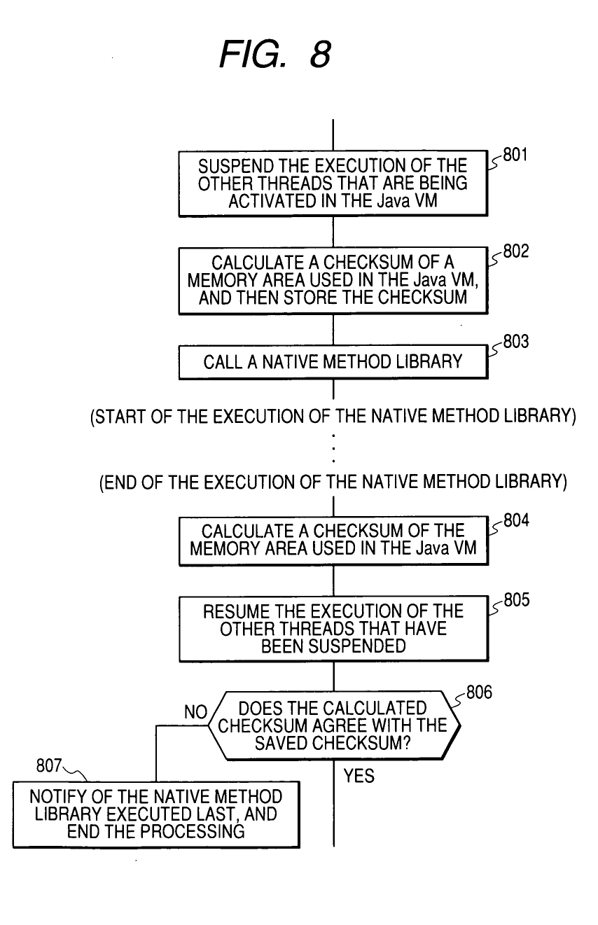

FIG. 8 is a flowchart illustrating processing of the steps 208 through 210 executed in the case where the OS does not have the memory protection function, and in a system capable of the multithread control, when a native method library is called from the Java VM, another thread operating in the Java VM can be stopped. In a step 801, the execution program 108 suspends all of other threads in the Java VM, which are currently activated, so that other threads activated in the Java VM do not access the memory area used in the Java VM, a checksum of which will be determined now. In a step 802, the native method library execution module 113 calculates a checksum of the memory area which has been reserved in the processing of the step 205 and which is used in the Java VM. Then, the native method library execution module 113 saves the checksum in some storage area.

In a step 803, the native method library execution module 113 calls the native method library. If the thread of the native method library updates the memory area, the processing continues just as it is even if the memory area is an invalid memory area.

When the processing returns from the native method library, the native method library execution module 113 determines a current checksum of the reserved memory area used in the Java VM in a step 804. Next, in a step 805, the execution program 108 resumes other threads in the Java VM, which have been suspended.

In the step 806, the invalid memory access detection module 114 compares the saved checksum with the checksum determined in the step 804. If they do not coincide with each other, in a step 807, the invalid memory access detection module 114 notifies of the native method library called last as an error message to the outside, and then ends the processing.

Incidentally, in the second and fourth embodiments, a checksum is calculated. However, instead of calculating a checksum, any function procedure may be used (for example, using a hash function, or using the result of data compression) if code information can be obtained as a result of the function procedure that uses contents of the memory area as an input, and if code information which corresponds to the contents of the memory area uniquely or with high probability can be obtained. As a matter of course, a case where the contents of the memory area are saved just as it is in a storage device such as a memory is also included.

In the embodiments described above, the thread management, the atomic transaction, and the like, used in the Java VM, all of which are required, are functions that are conventionally included in the Java VM. Therefore, they will not be detailed.

According to the present invention, during or after the execution of a program operating in a system in which memory access can be freely performed, said program being called from a program operating in a system in which invalid memory access does not occur, it is possible to early detect the occurrence of invalid memory access.

1. A method of detecting invalid memory access used in a computer which executes a language system having a specific memory management function; a first program code that is executed under the control of the language system, and that accesses a first memory area reserved by the language system; and a second program code that is directly executed under the control of OS, and that accesses a second memory area reserved by the OS; wherein said method executed by the language system detects invalid memory access to the first memory area caused by the second program code, said method comprising the steps of:
allowing said language system to set the memory protection of the first memory area before the first program code calls the second program code;
calling and executing the second program code;
when a memory protection exception occurs, notifying of invalid memory access caused by the second program code to outside; and
when the execution of the second program code ends and the control returns to the language system, disabling the memory protection of the first memory area.

2. A method of detecting invalid memory access according to claim 1, wherein:
when said memory protection exception occurs, if it is detected that the first program code performs normal memory access to the first memory area, said language system disables the memory protection to allow the normal memory access, and then enables the memory protection again.

3. A method of detecting invalid memory access according to claim 1, wherein:
if the first program code is executed under the multithread control, said language system suspends the execution of other threads while a certain thread calls the second program code.

4. A method of detecting invalid memory access used in a computer which executes a language system having a specific memory management function; a first program code that is executed under the control of the language system, and that accesses a first memory area reserved by the language system; and a second program code that is directly executed under the control of OS, and that accesses a second memory area reserved by the OS; wherein said method executed by the language system detects invalid memory access to the first memory area caused by the second program code, said method comprising the steps of:
allowing said language system to save code information associated with the contents of the first memory area before the first program code calls the second program code;
calling and executing the second program code;
when the execution of the second program code ends and the control returns to the language system, judging whether or not code information associated with the contents of the first memory area coincides with the saved code information; and
if the code information associated with the contents of the first memory area does not coincide with the saved code information, notifying of invalid memory access caused by the second program code to outside.

5. A method of detecting invalid memory access according to claim 4, wherein:
when it is detected that while the second program code is called the first program code normally updates the first memory area, said language system updates the saved code information based on code information associated with contents of the first memory area updated.

6. A method of detecting invalid memory access according to claim 4, wherein:
if the first program code is executed under the multithread control, said language system suspends the execution of other threads while a certain thread calls the second program code.

7. A program used in a computer which executes a language system having a specific memory management function; a first program code that is executed under the control of the language system, and that accesses a first memory area reserved by the language system; and a second program code that is directly executed under the control of OS, and that accesses a second memory area reserved by the OS; said program allowing said computer to execute language system's functions of detecting invalid memory access to the first memory area caused by the second program code;
wherein said computer executes the functions of:
setting the memory protection of the first memory area before the first program code calls the second program code;
calling and executing the second program code;
when a memory protection exception occurs, notifying of invalid memory access caused by the second program code to outside; and
when the execution of the second program code ends and the control returns to the language system, disabling the memory protection of the first memory area.

8. A program according to claim 7, allowing the computer to execute the functions of:
when said memory protection exception occurs, if it is detected that the first program code performs normal memory access to the first memory area, disabling the memory protection, allowing the normal memory access, and enabling the memory protection again.

9. A program according to claim 7, allowing the computer to execute the function of:
if the first program code is executed under the multithread control, suspending the execution of other threads while a certain thread calls the second program code.

10. A program used in a computer which executes a language system having a specific memory management function; a first program code that is executed under the control of the language system, and that accesses a first memory area reserved by the language system; and a second program code that is directly executed under the control of OS, and that accesses a second memory area reserved by the OS; said program allowing said computer to execute language system's functions of detecting invalid memory access to the first memory area caused by the second program code;
wherein said computer executes the functions of:
saving code information associated with the contents of the first memory area before the first program code calls the second program code;
calling and executing the second program code;
when the execution of the second program code ends and the control returns to the language system, judging whether or not code information associated with the contents of the first memory area coincides with the saved code information; and
if the code information associated with the contents of the first memory area does not coincide with the saved code information, notifying of invalid memory access caused by the second program code to outside.

11. A program according to claim 10, allowing the computer to execute the functions of:
when said memory protection exception occurs, if it is detected that the first program code performs normal memory access to the first memory area, disabling the memory protection, allowing the normal memory access, and enabling the memory protection again.

12. A program according to claim 10, allowing the computer the function of:
if the first program code is executed under the multithread control, suspending the execution of other threads while a certain thread calls the second program code.

13. A language system used in a computer which executes a language system having a specific memory management function; a first program code that is executed under the control of the language system, and that accesses a first memory area reserved by the language system; and a second program code that is directly executed under the control of OS, and that accesses a second memory area reserved by the OS; wherein said language system detects invalid memory access to the first memory area caused by the second program code, said language system comprising:
means for setting memory protection of the first memory area before the first program code calls the second program code, for calling and executing the second program code, and for notifying of invalid memory access caused by the second program code to outside when a memory protection exception occurs; and
means for disabling the memory protection when the execution of the second program code ends and the control returns to the language system.

14. A language system according to claim 13, further comprising:
means, when said memory protection exception occurs, if it is detected that the first program code performs normal memory access to the first memory area, for disabling the memory protection, allowing the normal memory access, and then enabling the memory protection again.

15. A language system according to claim 13, further comprising:
means, if the first program code is executed under the multithread control, for suspending the execution of the other threads while a certain thread calls the second program code.
